(19) United States
(12) Patent Application Publication
(10) Pub. No.: US 2010/0302174 A1
(43) Pub. Date: Dec. 2, 2010

(54) ATTACHABLE DISPLAY CONTROL SYSTEM

(76) Inventors: David J. Cornell, Scottsville, NY (US); David R. Dowe, Rochester, NY (US); Roland R. Schindler, II, Pittsford, NY (US)

Correspondence Address: Peter P. Hernandez;Patent Legal Staff, Eastman Kodak Company, 343 State Street, Rochester, NY, 14650-2201, US

(21) Appl. No.: 12/473,596

(22) Filed: May 28, 2009

(51) Int. Cl. G06F 3/041

(52) U.S. Cl. 345/173

(57) ABSTRACT

A digital picture frame includes a display on which images are displayed; a detachable and re-attachable apparatus that includes: (i) a mounting base; (ii) a transparent overlay mounted in the mounting base; wherein the overlay spans the display and includes a first side that receives pressure from a user for indicating a mode preference and a second side opposite the first side; (iii) a plurality of activation mechanisms each of which activates a mode preference and are adjacent the second side of the transparent overlay; wherein a particular activation mechanism is activated when user pressure is received within a predetermined spatial relationship to the particular activation mechanism; and (iv) an attachment mechanism that permits the apparatus to be attached and detached from the display.

### FIELD OF THE INVENTION

The present invention generally relates to image displays and more particularly to an assembly that is attachable to the display and that functions as a user-interface so that the display is less likely to be damaged due to ordinary usage.

### BACKGROUND OF THE INVENTION

A wide variety of touch sensitive display devices are known to those of skill in the art of user interface technology. Such display devices are known in the art as touch screen systems. In particular, highly sensitive finger-tip or stylus detection, touch screen systems are well known and are commonly used in a wide variety of applications. Examples of such touch sensitive display devices include, but are not limited to, resistant to touch detection systems, capacitive touch detection systems, and other forms of touch detection. Such touch sensitive display systems can have integral touch sensitive technology or such technology can be added separately. For example, the Magic Touch Add-On Touch Screen sold by KEYTEC, Garland, Tex., USA is an add on device that can be mounted to the face of a display such as an LCD monitor and that provides a touch sensitive area through which the images presented by the LCD monitor can be seen. Such a Touch Screen Kit is fixed onto the display and then linked to an input port of a personal computer. The computer must have a driver installed to interpret the signals provided by the touch screen kit. It will be appreciated that such systems are complex systems that add significantly to the costs of display devices that incorporate such screens.

There have been some efforts to reduce the costs of such display systems resulting for example, in the systems that are described in GB2180342 entitled “Pressure Sensitive Device” and in Roberts US Patent Application Number 2003/0210235 A1. These efforts generally describe the use of transparent sheets that are positioned between an image presentation area and a user. The transparent sheets are physically connected to pressure sensitive touch sensors. Each of the touch sensors produces a sensor signal in response to a touch applied to the touch surface. A control system coupled to the touch sensors, receives sensor signals and develops a plurality of reference levels for a force sensitive touch signal, selects or more of the plurality of reference levels based on information acquired from the touch signal, and determines the touch location using the selected reference levels.

Even where such systems are used, cost and complexity problems remain and these cost and complexity challenges impose a difficult decision on the designers and manufacturers of display devices. In particular, for some cost conscious display device users, touch sensitive interactions may be of little interest, while for other users, the range of additional interaction opportunities enabled by touch sensitive displays may be considered essential. This places a manufacturer and designer of such systems to make a difficult design choice as to whether to incorporate a touch sensitive display system and the extra cost associated therewith into a particular model of display device.

Further complicating this design decision is the problem of service life. The very technology that makes such touch sensitive systems capable of accurately sensing contact can also make such systems vulnerable to damage through repeated use or through incidental contact. Over time, continuous usage of the interface may necessitate the interface needing repair or replacement. Due to the integration of the components of the kiosk or picture frame, components integrally connected to the display may also need replacing. In any event, repair or replacement costs are undesirable.

What is still needed in the art is a way to provide a touch sensitive capability for a display device when desired and in a manner that has long service life and that provides adequate sensitivity to touch. Further, a need exists for a removable interface that is cost efficient so that maintenance costs are reduced.

### SUMMARY OF THE INVENTION

The present invention is directed to overcoming one or more of the problems set forth above. Briefly summarized, according to one aspect of the invention, the invention resides in a digital picture frame comprising: (a) a display on which images are displayed; (b) a detachable and re-attachable sub-assembly comprising: (i) a mounting base; (ii) a transparent overlay mounted in the mounting base; wherein the overlay spans the display and includes a first side that receives pressure from a user for indicating a mode preference and a second side opposite the first side; (iii) a plurality of activation mechanisms each of which activates a mode preference and are adjacent the second side of the transparent overlay; wherein a particular activation mechanism is activated when user pressure is received within a predetermined spatial relationship to the particular activation mechanism; and (iv) an attachment mechanism that permits the sub-assembly to be attached and detached from the display.

These and other objects, features, and advantages of the present invention will become apparent to those skilled in the art upon a reading of the following detailed description when taken in conjunction with the drawings wherein there is shown and described an illustrative embodiment of the invention.

### Advantageous Effect of the Invention

The present invention has the advantage of preserving the integrity of displays by providing a user interface which prevents damage to the display due to user contact and the like during operation and which is cost efficient, detachable, seam-less to the user and can be retrofitted to existing displays.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

While the specification concludes with claims particularly pointing out and distinctly claiming the subject matter of the present invention, it is believed that the invention will be better understood from the following description when taken in conjunction with the accompanying drawings, wherein:

FIG. 1 is a top view of the sub-assembly of the present invention designed for removable attachment to a display;

FIG. 2 is cross-sectional view of FIG. 1 through line 2-2;

FIG. 3 is a partially-exploded perspective view of the sub-assembly attached to a decorative cover which together form an assembly;

FIG. 4 is a perspective view of the assembly and a display in their non-attached state;

FIG. 5 is a perspective view of the assembly when the assembly and the display are attached;

FIG. 6 is a cross-sectional view of the sub-assembly of FIG. 4; and

FIG. 7 is a cross-sectional view of the assembly and the display in their attached state of FIG. 5.

### DETAILED DESCRIPTION OF THE INVENTION

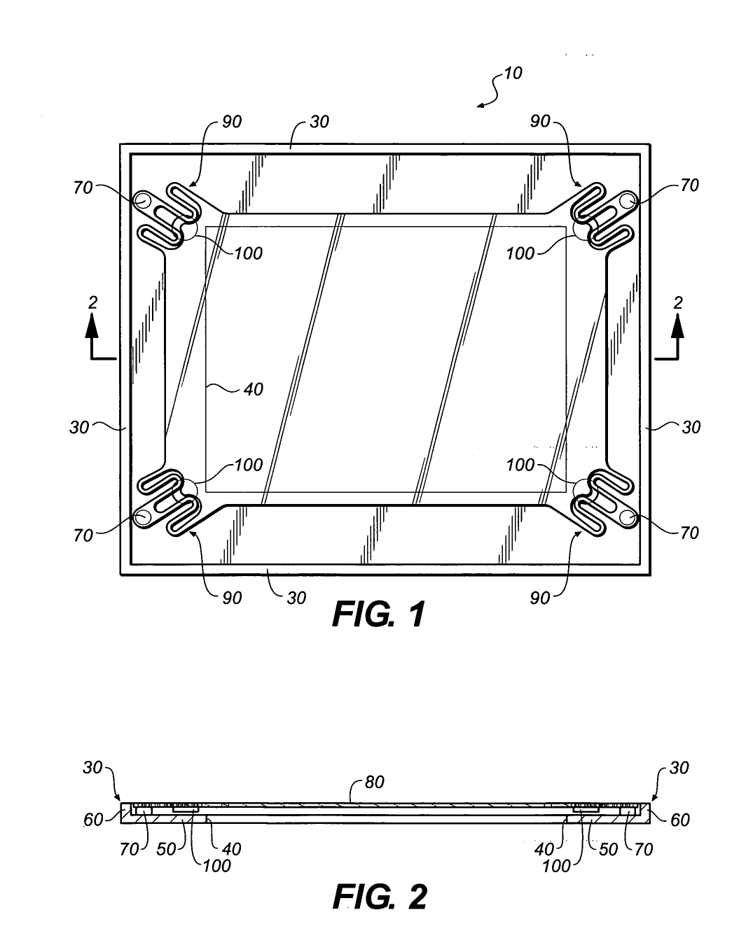

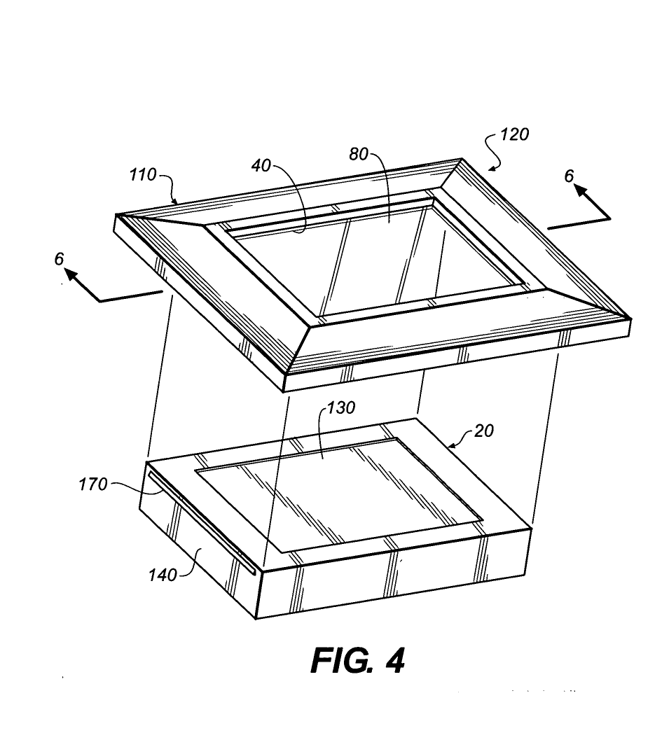

Turning now to FIGS. 1 and 2, there are shown a top and cross-sectional view of the sub-assembly 10 that attaches to a display 20 (see FIG. 4). The sub-assembly 10 includes a rectangular-shaped bracket 30 having a rectangular-shaped hollowed-out portion 40 through which the display 20 is eventually viewed when the display 20 is disposed underneath the hollowed-out portion 40. It is noted that the bracket 30 also includes a pedestal portion 50 and a lip portion 60 extending perpendicular from the pedestal portion 50. Four supports 70 are disposed on the pedestal portion 50 for supporting a transparent cover glass 80 that rests (i.e., abuts) thereon. The cover glass 80 includes four groups of finger projections 90, three in each group, that provide increased flexibility near the corner sections of the cover glass 80, and the middle finger projection of each group 90 rests respectively on a support 70. The cover glass 80 is transparent so that the display 20, when attached, is viewable by a viewer through the cover glass 80. An interface activator 100, preferably a magnet, also is disposed on the pedestal portion 50 so that, when a user presses the cover glass 80 in the vicinity of the interface activator 100, the interface activator 100 is activated as will be described in detail hereinbelow. The interface activator 100 is adhered to the cover glass 80 via any suitable adhesive and is in a slightly spaced-apart relationship when the pedestal portion 50 is its normal non-compressed state (user pressure is absent), and the interface activator 100 is moved toward the pedestal portion 50 when the user presses against the cover glass 80. When the user presses against the cover glass 80, the interface activator 100 may contact the pedestal portion 50 or may be in closer spaced-apart relationship with the pedestal portion 50 than when in its normal state. It is noted that when two interface activators 100 share a portion of its predetermined spatial relationship and, when the user presses the shared spatial relationship, a time delay is enabled in order to determine which interface activator 100 is more likely desired. It is noted that, although a magnet is preferably shown as the interface activator 100, a mechanical switch, reflective surface or the like may also be used. Those skilled in the art will recognize that, according to the type of interface activator 100 that is used, the sensor 180 (see FIG. 7) will be a corresponding receiving sensor that functionally works with the chosen interface activator 100.

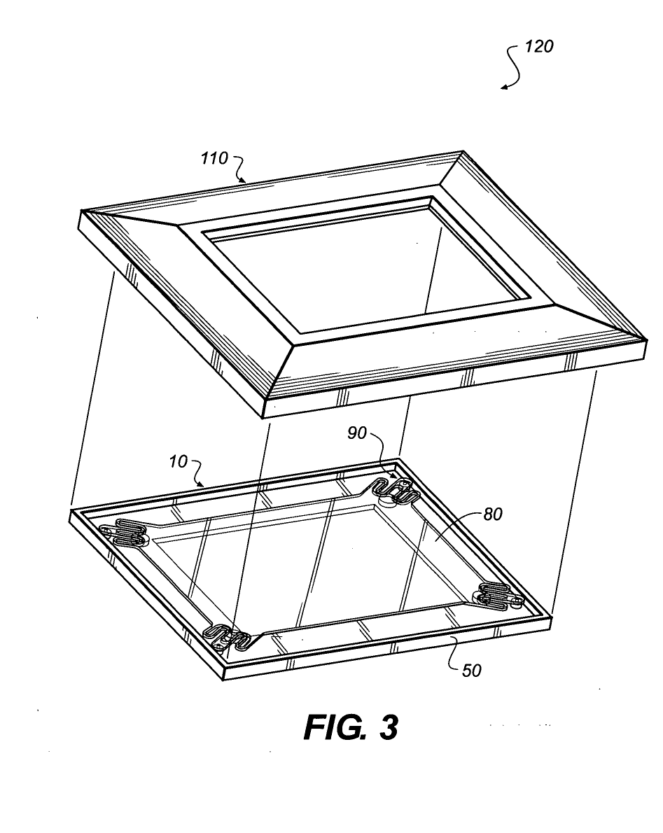

Referring to FIG. 3, there is shown the sub-assembly 10 in the lower portion of the drawing and, in the upper portion of the drawing, there is shown a wooden frame or a wood-simulated frame 110 disposed over the sub-assembly 10 so that the an aesthetically-pleasing design is presented on the user-viewable side of the assembly 120 (hereinafter the sub-assembly 10 and the frame together are referred to as the assembly 120 both of which are self-contained when either separate or when assembled together). The frame 110 is disposed around a periphery of the cover glass 80 (shown in the lower portion of drawing) and may be designed in a manner representative of designs of picture frames for still images. That is, the frame 110 may be wood or wood-simulated, brass or brass-simulated, or any number of other materials typically used for still image picture frames.

Referring to FIG. 4, there is shown the assembly 120 and a representative display 20 over which the assembly 120 is placed. It is noted that the display 20 may be a digital picture frame, television, kiosk or the like. The viewing portion 130 of the display 20 is placed beneath and spanning the hollowed-out portion 40 and, since the cover glass 80 is transparent, the display 20 is viewable by a user. The representative display 20 includes an encasing 140 surrounding the viewing portion 130, and the surface of the viewing portion 130 is not flush with the surface of the encasing 140, but is slightly below the encasing level so that, when the assembly 120 is attached thereto, the display surface is not damaged or the like.

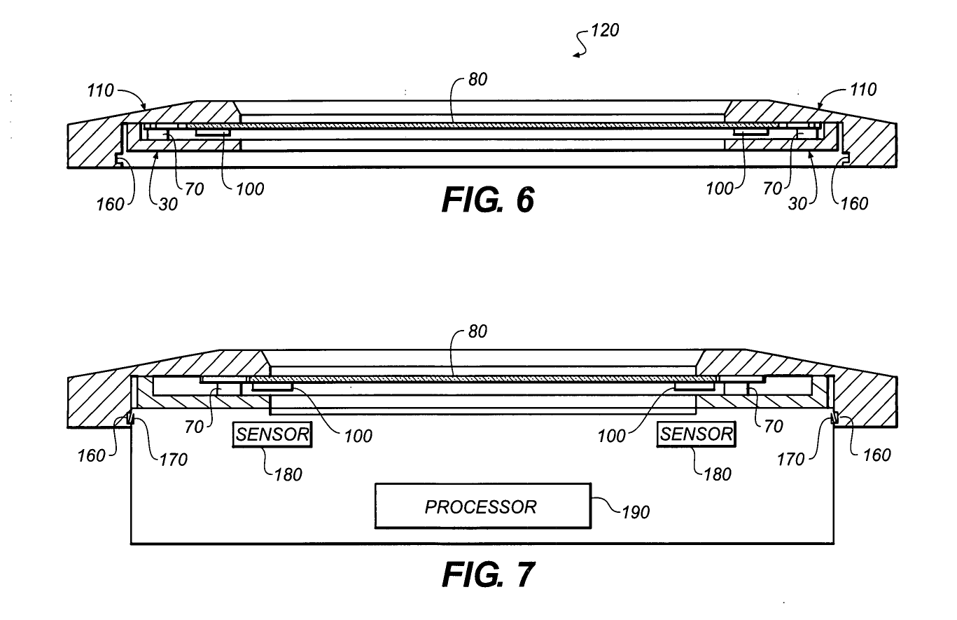

Referring to the upper portion of FIG. 4 and FIG. 6, the assembly 120 is shown having the previously discussed components—the bracket 30, supports 70, interface activator 100, cover glass 80, and frame 110. It is noted that the frame 110 includes notched-out portions 160 into which fits a projection 170 (see FIG. 7) of the display 20 so that the assembly 120 and display 20 are integrated and stabilized as a single unit. It is noted that, although a frame 110 is shown for providing the means to which the sub-assembly 10 is attached to the display 20, various other mechanisms may be used in lieu of the notched-out portion 160 of the frame 110. For example, those skilled in the art may alter the bracket 30 so that it is the mechanism by which the sub-assembly 10 is attached to the display 20. Still further, the cover glass 80 may be altered with an extension that extends over the bracket 30 and connects to the display 20. It will also be appreciated that in still other embodiments, the interface activators 100 themselves can be used to join the cover glass 80 to display 20, such as by providing removable mounting features such as spongy adhesive tape, threads, magnetic features, or adhesives on the interface activators 100 so as to allow these devices to be used to provide the physical link between the cover glass 80 and the display device 20.

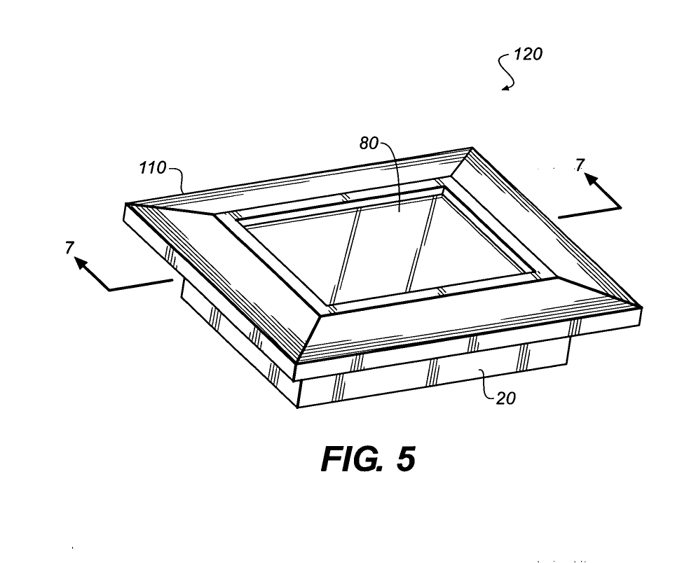

Referring to FIG. 5, there is shown the assembly 120 mounted on the display 20, and referring to FIG. 7, there is shown a cross-sectional view of the assembly 120. As best seen in FIG. 7, the display 20 includes four Hall-Effect sensors 180 (only two of which are visible from the cross section) each of which is mated with an interface activator 100. In operation, when the user presses against the cover glass 80 near a particular interface activator 100, the interface activator 100 is moved toward downwardly and the magnetic field between the interface activator 100 and the Hall-Effect sensor 180 is altered causing the sensor 180 to send a signal to the processor 190 that the user wishes a mode of operation or function associated with that particular interface activator 100 to be activated (i.e., a touch activated feature). The processor 190, in turn, directs the corresponding mode of operation (function) or feature to be activated or altered accordingly. Although a Hall-Effect sensor 180 is preferred, the sensor 180 may also be an optical sensor or the like so that it functionally works with the interface activator 100 as will be apparent to those skilled in the art.

From the foregoing, it can be appreciated that, since the user presses the cover glass 80, the display 20 is not the user interface for the user so that it is not exposed to typical degradation caused by ordinary use. It is appreciated that the assembly 120 is relatively inexpensive as compared to the display 20 and is more easily replaced or repaired than the display 20. As an illustrative embodiment, if the display 20 is a digital picture frame, the display may display “arrows” or the like indicating fast forwarding of images or reverse sequencing of images respectively spatially close to a particular interface activator 100. The user presses the cover glass 80 near the desired “arrow” in which case the particular function or feature is activated accordingly.

It will be appreciated from the foregoing that a designer or manufacturer of display devices will, using the devices described herein be able to provide a display device to which touch sensitive capabilities can be added as desired, either by a customer after purchase or otherwise. This simplifies the designers challenge in designing such systems as a non-touch sensitive model can be designed and manufactured with low cost, replaceable, touch sensitive capabilities added thereto as desired.

The invention has been described in detail with particular reference to certain preferred embodiments thereof, but it will be understood that variations and modifications can be effected within the spirit and scope of the invention.

### Parts List

10 sub-assembly
20 display
30 bracket
40 hollowed-out portion
50 pedestal portion
60 post portion
70 supports
80 cover glass
90 finger projections
100 interface activator
110 frame
120 assembly
130 viewing portion
140 encasing
160 notched-out portion
170 projection
180 sensors
190 processor

1. A digital picture frame comprising:
(a) a display on which images are displayed;
(b) a detachable and re-attachable apparatus comprising:
(i) a mounting base;
(ii) a transparent overlay mounted in the mounting base; wherein the overlay spans the display and includes a first side that receives pressure from a user for indicating a preferred mode of operation and a second side opposite the first side;
(iii) a plurality of activation mechanisms each of which activates a mode of operation and are adjacent the second side of the transparent overlay; wherein a particular activation mechanism is activated when user pressure is received within a predetermined spatial relationship to the particular activation mechanism; and
(iv) an attachment mechanism that permits the apparatus to be attached and detached from the display.

2. The digital frame as in claim 1, wherein when two activation mechanisms share a portion of its predetermined spatial relationship and, when the user presses the shared spatial relationship, a time delay is enabled in order to determine which activation mechanism is more likely desired.

3. The digital frame as in claim 1 further comprising a support disposed abutting the second side of the overlay and on the mounting base so that the transparent layer is in a spaced-apart relationship with the activation mechanism when user pressure is absent.

4. The digital frame as claim 3, wherein the activation mechanisms are mechanical switches.

5. The digital frame as in claim 1 further comprising a frame disposed around a periphery of the overlay.

6. The digital frame as in claim 5, wherein the activation mechanisms are positioned between the frame and the display.

7. The digital frame as in claim 1, wherein the activation mechanisms are positioned about a periphery of the overlay and wherein the activation mechanisms mechanically join the overlay to the display in a detachable manner.

8. A self-contained apparatus that is attachable to a display for permitting the display to have one or more touch-activated features, the self-contained apparatus comprising:
(a) a mounting base;
(b) a transparent overlay mounted in the mounting base; wherein the overlay includes a first side that receives pressure from a user for indicating a preferred mode of operation and a second side opposite the first side;
(c) a plurality of activation mechanisms each of which activates a mode of operation and are adjacent the second side of the transparent overlay; wherein a particular activation mechanism is activated when user pressure is received within a predetermined spatial relationship to the particular activation mechanism; and
(d) an attachment mechanism that permits the apparatus to be attached and detached from the display.

9. The self-contained apparatus as in claim 8, wherein when two activation mechanisms share a portion of its predetermined spatial relationship and, when the user presses the shared spatial relationship, a time delay is enabled in order to determine which activation mechanism is more likely desired.

10. The self-contained apparatus as in claim 8 further comprising a support disposed abutting the second side of the overlay and on the mounting base so that the transparent layer is in a spaced-apart relationship with the activation mechanism when user pressure is absent.

11. The self-contained apparatus as claim 10, wherein the activation mechanisms are mechanical switches.

12. The self-contained apparatus as in claim 8 further comprising a frame disposed around a periphery of the overlay.
